(19) United States
(12) Patent Application Publication
(10) Pub. No.: US 2017/0103637 A1
(43) Pub. Date: Apr. 13, 2017

(54) Personal Space Warning Assembly

(71) Applicant: Linda Brown, Chicago, IL (US)

(72) Inventor: Linda Brown, Chicago, IL (US)

(21) Appl. No.: 14/881,933

(22) Filed: Oct. 13, 2015

(51) Int. Cl. G08B 21/04; G08B 21/22; G08B 3/10

(52) U.S. Cl. CPC G08B 21/0469; G08B 3/10; G08B 21/22

(57) ABSTRACT

A personal space warning assembly includes a mount for positioning on a person's head. A sensor is mounted on the mount and is configured to detect if a person is within a predetermined distance of the mount. A sound emitter is electrically coupled to the sensor and emits an audible sound when the sensor detects a person.

### BACKGROUND OF THE DISCLOSURE

### Field of the Disclosure

The disclosure relates to oncoming attack warning devices and more particularly pertains to a new oncoming attack warning device for warning a person that another person is approaching them from behind.

### SUMMARY OF THE DISCLOSURE

An embodiment of the disclosure meets the needs presented above by generally comprising a mount for positioning on a person's head. A sensor is mounted on the mount and is configured to detect if a person is within a predetermined distance of the mount. A sound emitter is electrically coupled to the sensor and emits an audible sound when the sensor detects a person.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a personal space warning assembly according to an embodiment of the disclosure.

FIG. 2 is a top view of an embodiment of the disclosure.

FIG. 3 is a front view of an embodiment of the disclosure.

FIG. 4 is a rear view of an embodiment of the disclosure.

FIG. 5 is a side in-use view of an embodiment of the disclosure.

FIG. 6 is a schematic view of an embodiment of the disclosure.

### DESCRIPTION OF THE PREFERRED EMBODIMENT

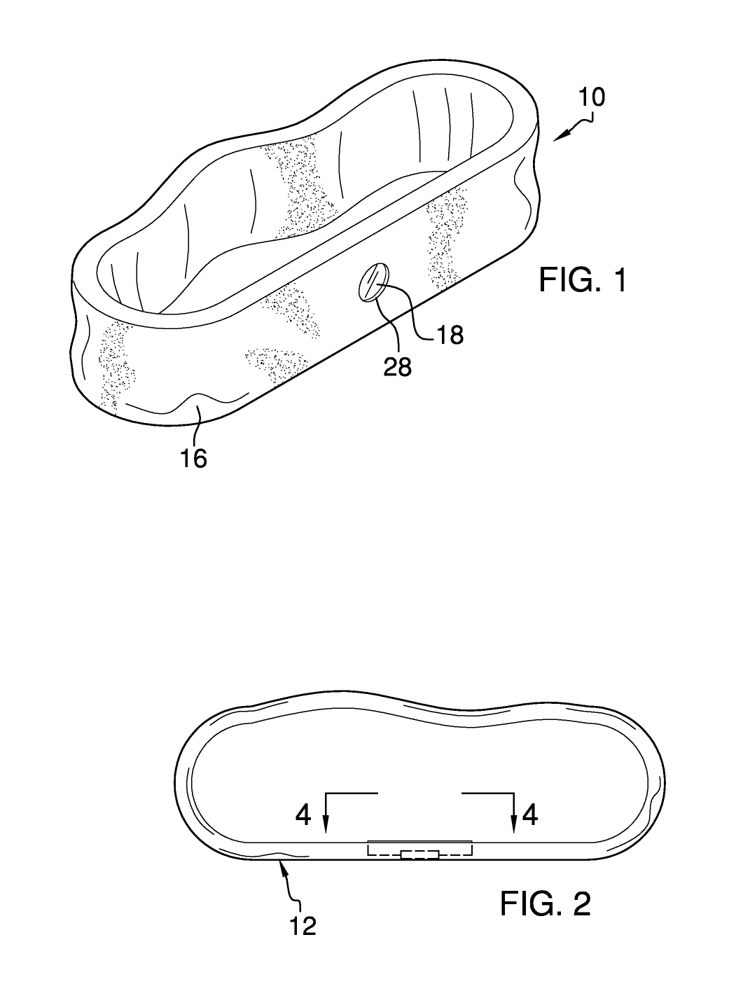

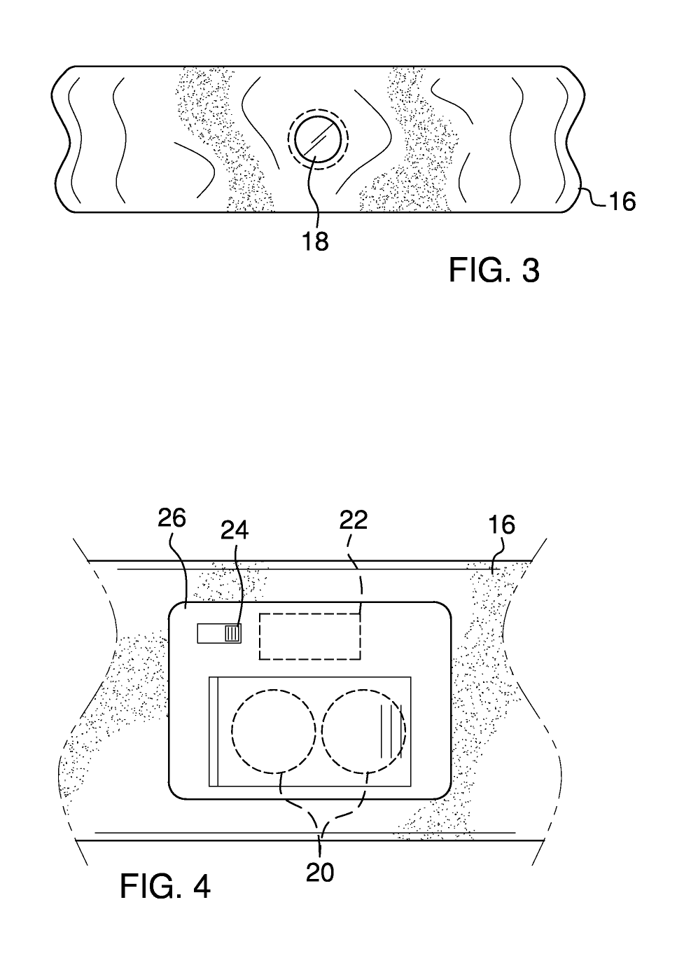

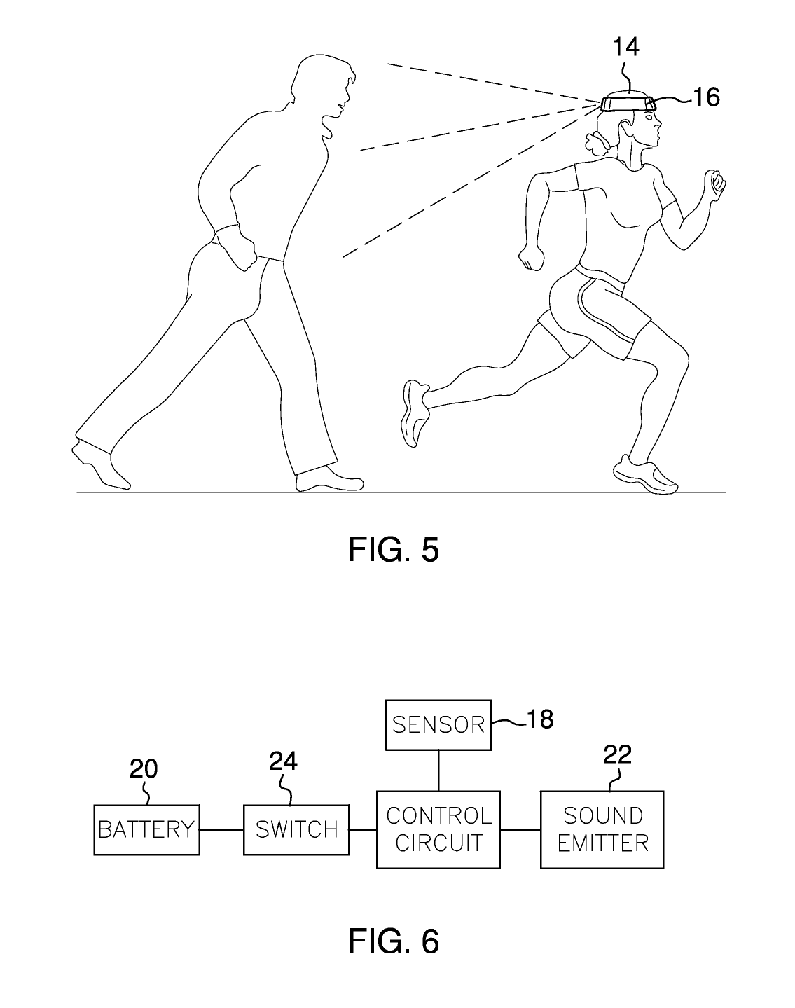

With reference now to the drawings, and in particular to FIGS. 1 through 6 thereof, a new oncoming attack warning device embodying the principles and concepts of an embodiment of the disclosure and generally designated by the reference numeral 10 will be described.

As best illustrated in FIGS. 1 through 6, the personal space warning assembly 10 generally comprises a mount 12 configured to be positioned on a person's head 14. The function of the mount 12 is to retain the entire assembly 10 on the person's head 14 and therefore may comprise any type of headwear. However, as shown in the Figures, the mount 12 may comprise a headband 16. The headband 16 may be formed in a closed loop of resiliently stretchable material which may further comprise cloth material.

A sensor 18 is mounted on the mount 12 and is configured to detect if a person is within a predetermined distance of the mount 12. The sensor 18 may comprise any type of proximity sensor however it may be beneficial if the sensor 18 comprises an infrared sensor so that only sources emitting heat will be detected by the sensor 18. The predetermined distance will generally be between 5.0 feet and 20. feet and more particularly between about 10.0 feet and 15.0 feet. A battery 20 is electrically coupled to the sensor 18 wherein the battery 20 and sensor 18 may each be mounted within a housing 26 that is positioned in the headband 16. The sensor 18 may extend through the headband 16 and is at least aligned with an opening 28 in the headband 16. A sound emitter 22 is electrically coupled to the sensor 18. The sound emitter 22 emits an audible sound when the sensor 18 detects a person. The audible sound will generally be relatively loud and at least 70 decibels. A switch 24 is electrically coupled to the battery 20 to selectively turn the sensor 18 on or off.

In use, the person would place the headband 16 on their head 14 such that the sensor 18 would be directed behind them. If another person were to attempt to attack the wearer of the assembly 10, the sensor 18 will activate the sound emitter 22 to alert the wearer that there is someone approaching them from behind. This will give the wearer time to prepare for being attacked. Further, as the sound emitter emits sound, it may startle and deter an attacker from assaulting the wearer of the headband 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A personal space warning assembly configured to sound an alarm when another person approaches within a predetermined distance, said assembly comprising:
a mount configured to be positioned on a person's head, wherein said mount comprises a headband, said headband being formed in a closed loop of resiliently stretchable material;
a sensor being mounted on said mount and being configured to detect if a person is within a predetermined distance of said mount, said predetermined distance being between 5.0 feet and 20.0 feet; and
a sound emitter being electrically coupled to said sensor, said sound emitter emitting an audible sound when said sensor detects a person, said sound emitted being greater than 70 decibels.

2. (canceled)

3. The personal space warning assembly according to claim 1, wherein said sensor comprises an infrared sensor.

4. A personal space warning assembly configured to sound an alarm when another person approaches within a predetermined distance, said assembly comprising:
a mount configured to be positioned on a person's head, said mount comprising a headband, said headband being formed in a closed loop of resiliently stretchable material;
a sensor being mounted on said mount and being configured to detect if a person is within a predetermined distance of said mount, said sensor comprising an infrared sensor, said predetermined distance being between 10.0 feet and 15.0 feet;
a battery being electrically coupled to said sensor; and
a sound emitter being electrically coupled to said sensor, said sound emitter emitting an audible sound when said sensor detects a person, said sound emitted being greater than 70 decibels.
